(19) United States
(12) Patent Application Publication
(10) Pub. No.: US 2007/0213882 A1
(43) Pub. Date: Sep. 13, 2007

(54) Thermal Management system

(76) Inventors: Takashi Inukai, Kawasaki-shi (JP); Yukihiro Urakawa, Kawasaki-shi (JP); Yuichi Baba, Kawasaki-shi (JP)

Correspondence Address: SPRINKLE IP LAW GROUP, 1301 W. 25TH STREET, SUITE 408, AUSTIN, TX, 78705, US

(21) Appl. No.: 11/698,709

(22) Filed: Jan. 26, 2007

(30) Foreign Application Priority Data
Mar. 13, 2006 (JP) 2006-068194

(51) Int. Cl. G05D 23/00

(52) U.S. Cl. 700/300

(57) ABSTRACT

A thermal management system according to an embodiment of the present invention comprises processing units which are provided in a chip, a performance monitor circuit which monitors performances of the processing units and outputs performance data, a thermo sensor which provided in the chip, the thermo sensor outputting a detection signal relating to a chip temperature, a temperature detector unit which outputs temperature data based on the detection signal, and a system controller which stores a table representing a relationship among the performances of the processing units, the chip temperature and a temperature of a hot spot, and estimates a temperature of the hot spot based on the performance data and the temperature data by using the table.

### CROSS-REFERENCE TO RELATED APPLICATIONS

This application is based upon and claims the benefit of priority from prior Japanese Patent Application No. 2006-068194, filed Mar. 13, 2006, the entire contents of which are incorporated herein by reference.

### BACKGROUND OF THE INVENTION

1. Field of the Invention

The present invention relates to a thermal management system of a semiconductor integrated circuit having an on-chip thermo sensor (thermo sensor embedded in a chip).

2. Description of the Related Art

In a highly sophisticated semiconductor integrated circuit, parallel operation, high speed operation and the like advance, and a rise of a chip temperature caused by such advancement becomes a problem.

When the chip temperature is equal to or greater than a certain limit, a phenomenon such as a transistor breakage or firing occurs, and thus, there is a need for a technique of preventing such a phenomenon.

As one of the above techniques, there is provided a management technique in which a thermo sensor is embedded in a chip, and when a chip temperature exceeds a predetermined value, a cooling fan is driven, a processing speed is lowered, and further, operation is stopped (refer to, for example, Jpn. Pat. Appln. KOKAI Publication No. 10-41466).

However, while a plurality of hot spots exist in a chip, a plurality of thermo sensors cannot often be allocated to be associated with the plurality of hot spots because of a chip area or an overhead in the number of pads (terminals).

For such a reason, conventionally, it has been difficult to precisely grasp temperatures of all the hot spots, and total thermal management has not been successfully carried out. Therefore, there occurs a problem that a temperature error must be considered, for example, a drive ratio of a cooling fan rises and a cooling cost is increased.

### BRIEF SUMMARY OF THE INVENTION

A thermal management system according to an aspect of the present invention comprises processing units which are provided in a chip, a performance monitor circuit which monitors performances of the processing units and outputs performance data, a thermo sensor which provided in the chip, the thermo sensor outputting a detection signal relating to a chip temperature, a temperature detector unit which outputs temperature data based on the detection signal, and a system controller which stores a table representing a relationship among the performances of the processing units, the chip temperature and a temperature of a hot spot, and estimates a temperature of the hot spot based on the performance data and the temperature data by using the table.

A thermal management system according to an aspect of the present invention comprises processing units which are provided in a chip, a performance monitor circuit which monitors performances of the processing units and outputs performance data, a replica circuit which replicates heat rates of the processing units based on the performance data, a thermo sensor adjacent to the replica circuit, the thermo sensor outputting a detection signal relating to a temperature of the replica circuit, a temperature detector unit which outputs temperature data based on the detection signal, and a system controller which stores a table representing a relationship between the temperature of the replica circuit and a temperature of a hot spot, and estimates the temperature of the hot spot based on the temperature data by using the table.

A thermal management system according to an aspect of the present invention comprises processing units which are provided in a chip, a redundancy control circuit provided in the chip, the redundancy control circuit outputting redundancy data which indicates use/disuse of the processing units, a thermo sensor provided in the chip, the thermo sensor outputting a detection signal relating to a chip temperature, a temperature detector unit which outputs temperature data based on the detection signal, and a system controller which stores a table representing use/disuse of the processing units and a relationship between the chip temperature and a temperature of a hot spot, and estimates the temperature of the hot spot based on the redundancy data and the temperature data by using the table.

A thermal management system according to an aspect of the present invention comprises processing units which are provided in a chip, thermo sensors which are provided in the chip, and a temperature detector unit which outputs temperature data relating to a chip temperature based on a detection signal of at least one of the thermo sensors, wherein use/disuse of the thermo sensors is determined based on use/disuse of the processing units.

A thermal management system according to an aspect of the present invention comprises a thermo sensor provided in a chip, the thermo sensor outputting a detection signal relating to a chip temperature, a first temperature detector unit which outputs first temperature data based on the detection signal, a second temperature detector unit which outputs second temperature data relating to a temperature of the outside of the chip, a power supply circuit which monitors power consumption of the chip and outputs power data, and a system controller which estimates a temperature of a hot spot from the first and second temperature data and the power data.

### BRIEF DESCRIPTION OF THE SEVERAL VIEWS OF THE DRAWING

FIG. 1 is a diagram showing a thermal management system according to a first embodiment;

FIG. 2 is a view showing a table to be stored in a system controller shown in FIG. 1;

FIG. 3 is a diagram showing a thermal management system according to a modified example of the first embodiment;

FIG. 4 is a view showing a table to be stored in a system controller shown in FIG. 3;

FIG. 5 is a flow chart showing a flow from forming a chip to thermal management;

FIG. 6 is a flow chart showing a flow of thermal management;

FIG. 7 is a diagram showing a thermal management system according to a second embodiment;

FIG. 8 is a view showing a table to be stored in a system controller shown in FIG. 7;

FIGS. 9A to 9C are diagrams each showing a positional relationship between a thermo sensor and a processing unit serving as a hot spot;

FIG. 10 is a diagram showing a thermal management system according to a modified example of the second embodiment;

FIG. 11 is a diagram showing a thermal management system according to a modified example of the second embodiment; and

FIG. 12 is a diagram showing a thermal management system according to a third embodiment.

### DETAILED DESCRIPTION OF THE INVENTION

A thermal management system of an aspect of the present invention will be described below in detail with reference to the accompanying drawing.

In examples of the present invention, the following three management techniques are proposed in order to solve a common problem of precisely grasping temperatures of all hot spots even by thermo sensors whose number is smaller than that of the hot spots.

A first technique is a management technique of determining a positional relationship between thermo sensors and a plurality of processing units, and estimating a temperature of a hot spot based on performances of the plurality of processing units and temperatures detected by the thermo sensors.

This technique is featured in that a relationship between the temperatures detected by the thermo sensors and the temperatures of actual hot spots is tested in advance with respect to a main combination of the performances of the plurality of processing units, and that the tested relationship is summarized in a table.

The performances of the processing units used here include the presence or absence and a frequency of activation as well as a type and quantity of a task.

According to such a technique, the temperatures of hot spots can be precisely estimated based on a table provided in advance even by the thermo sensors whose number is smaller than that of the hot spots, as long as the performances of the processing units and the temperatures detected by the thermo sensors are identified.

Therefore, total thermal management of precisely grasping the temperatures of all the hot spots can be achieved.

A second technique is a management technique applied to a semiconductor integrated circuit having a logic redundancy function, the technique estimating temperatures of hot spots based on redundancy data and temperatures detected by thermo sensors.

The logic redundancy function used here designates a technique of, even if a failure occurs with some of a plurality of processing units, disabling use of such a faulty processing unit, and enabling use of the remaining normal processing units, thereby determining that no failure occurs with a chip.

In addition, the redundancy data used here designates data for specifying a normal processing unit in a chip. In other words, the redundancy data denotes data indicating a positional relationship between a thermo sensor and a normal processing unit serving as a hot spot.

This technique is featured in that a relationship between temperatures detected by the thermo sensors and temperatures of actual hot spots is tested in advance with respect to all combinations of logic redundancy (use/disuse) of a plurality of processing units, and that the tested redundancy is summarized in a table.

According to such a technique, temperatures of hot spots can be precisely estimated based on a table provided in advance even by thermo sensors whose number is smaller than that of hot spots, as long as the redundancy data and the temperatures detected by the thermo sensors are identified.

Therefore, total thermal management of precisely grasping the temperatures of all the hot spots can be achieved.

A third technique is a management technique of detecting a chip internal average temperature a (macroscopic temperature) and a chip internal minimum temperature (local temperature), and then, estimating a chip internal maximum temperature (hot spot temperature) based on both of the average and minimum temperatures.

The chip internal average temperature is detected by monitoring power consumption of a whole chip by means of a voltage regulator module (VRM) serving as a power supply circuit. The chip internal minimum temperature is detected by a thermo sensor.

This technique is featured in that, for example, assuming that a temperature distribution is expressed by a linear equation, a chip internal maximum temperature Tmax is obtained by Tmax=Tj+A×(Tj−Tmin), wherein Tmin denotes a chip internal minimum temperature detected by a thermo sensor; Tj denotes a chip internal average temperature; and A denotes a parameter determined by testing (including analysis made at the time of designing).

A portion at which the chip internal temperature is the lowest depends on a layout of processing units. In general, this portion is assumed to be a corner of a chip, and thus, a thermo sensor is allocated there.

According to such a technique, even by thermo sensors whose number is smaller than that of hot spots, temperatures of the hot spots can be precisely estimated by detecting the chip internal average temperature and the chip internal minimum temperature.

Consequently, total thermal management of precisely grasping the temperatures of all the hot spots can be achieved.

While these three techniques have respectively advantageous effects solely, all the techniques are used in combination or two of them are used in combination, whereby, further precise total thermal management can be achieved.

Now, some of embodiments seeming to be the best will be described here.

### FIRST EMBODIMENT

In a first embodiment, explanation will be given to a thermal management system of a semiconductor integrated circuit that achieves a management technique of estimating temperatures of hot spots based on performances of a plurality of processing units and temperatures detected by thermo sensors.

FIG. 1 shows a thermal management system according to the first embodiment.

A plurality of processing units (#1, #2, #3 and #4) 12 are allocated in a chip (semiconductor integrated circuit) 11. Each of the processing units 12 serves as a hot spot at the time of operation.

Further, a performance monitor circuit 13 and a thermo sensor 14 are allocated in the chip 11.

The performance monitor circuit 13 monitors performances of the plurality of processing circuits 12, and outputs them as performance data to the outside of the chip 11. The performances of the plurality of processing circuits 12 are determined by a control circuit embedded in the chip 11 or are determined by a control circuit provided outside of the chip 11.

The thermo sensor 14 is composed of, for example, an on-chip thermal diode (OTD), and outputs to the outside of the chip 11 a detection signal that depends on a chip temperature.

A temperature detector unit 15 obtains a chip temperature based on the detection signal from the thermo sensor 14, and outputs the obtained chip temperature as temperature data.

Although in this embodiment, the thermo sensor 14 is allocated in the chip 11, and the temperature detector unit 15 is allocated outside of the chip 11, both of them can be allocated in the chip 11 instead of these allocations.

A system controller 16 estimates a temperature of a hot spot based on the performance data provided from the performance monitor 13 and the temperature data provided from the temperature detector unit 15, and then, outputs a control signal that controls start/stop of a cooling system (for example, cooling fan) 17.

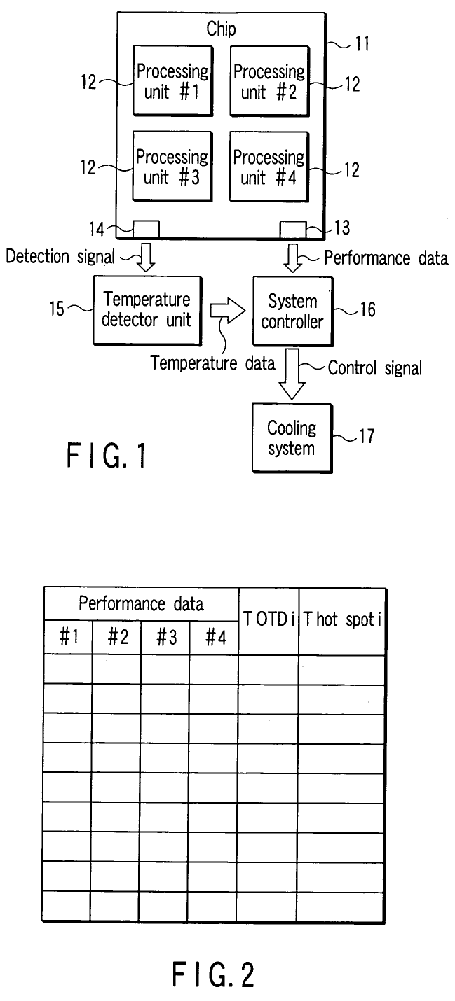

Temperatures of hot spots are, for example, as shown in FIG. 2, estimated based on a table (correlation data) summarizing a relationship among the performance data on the plurality of processing units (#1, #2, #3 and #4) 12, a temperature “T OTD i” detected by the thermo sensor 14, and an actual hot spot temperature “T hot spot i”.

This table is obtained in advance by testing the chip 11 before shipment.

Although in this embodiment, only one thermo sensor 14 is allocated in the chip 11, a plurality of thermo sensors 14 may be allocated in the chip instead.

In addition, a positional relationship between processing circuits 12 and thermo sensors 14 in the chip 11 is not limited in particular. However, it should be noted that, if such a positional relationship changes, a table (correlation data) shown in FIG. 2 changes as well.

According to this embodiment, the temperatures of hot spots can be precisely grasped by thermo sensors whose number is smaller than conventionally.

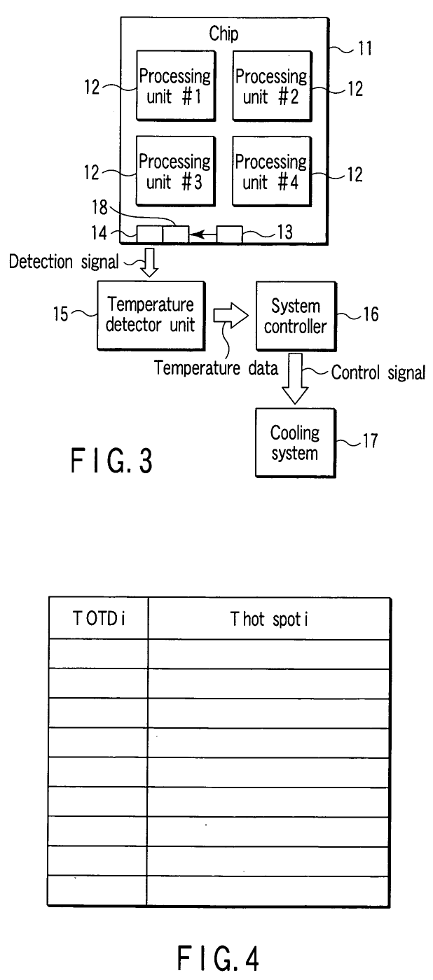

FIG. 3 shows a thermal management system according to a modified example of the first embodiment.

The modified example is featured in that a replica circuit 18 in a chip 11 is operated based on performance data without outputting the performance data to the outside of the chip 11, and that a temperature of a hot spot is estimated by detecting a temperature of the replica circuit 18 by use of a thermo sensor 14.

Although a performance monitor circuit 13 monitors performances of a plurality of processing circuits 12 as in the first embodiment, the circuit does not output the monitored performances as performance data to the outside of the chip 11. The performance data is supplied to the replica circuit 18 embedded in the chip 11.

The replica circuit 18 is composed of a circuit for replicating a plurality of processing units (#1, #2, #3 and #4) 12 serving as hot spots. Specifically, the replica circuit 18 replicates heat rates of the plurality of processing units 12 at the time of operation. Here, the replica circuit 18 does not need to replicate real heat rates of the plurality of processing units 12.

The replica circuit 18 may be composed of miniatures of the plurality of processing units 12 or may be composed of circuits that are completely different from the plurality of processing units 12.

The thermo sensor 14 is composed of, for example, an OTD, and is disposed adjacent to the replica circuit 18. The thermo sensor 14 outputs to the outside of the chip 11 a detection signal depending on a temperature of the replica circuit 18.

A temperature detector unit 15 obtains a temperature of the replica circuit 18 based on the detection signal provided from the thermo sensor 14, and outputs the obtained temperature as temperature data. Also in this embodiment, the thermo sensor 14 and the temperature detector unit 15 can be allocated in the chip 11.

A system controller 16 estimates a temperature of a hot spot based on temperature data provided from the temperature detector unit 15, and outputs a control signal that controls start/stop of a cooling system (for example, cooling fan) 17.

Temperatures of hot spots are, for example, as shown in FIG. 4, estimated based on a table (correlation data) summarizing a relationship between a temperature “T OTD i” of the replica circuit 18 detected by the thermo sensor 14 and an actual hot spot temperature “T hot spot i”. This table is obtained in advance by testing the chip 11 before shipment.

In this modified example, the temperature data “T OTD i” reflects performance data on the plurality of processing units 12. For this reason, unlike FIG. 2, the performance data on the plurality of processing units 12 are not included in the table shown in FIG. 4. Consequently, a burden on the system controller 16 is reduced.

In addition, since there is no need for outputting the performance data to the outside of the chip 11, the number of terminals on the chip 11 can be reduced.

In this modified example, it is sufficient if one thermo sensor 14 is allocated in the vicinity of the replica circuit 18. Further, the performance monitor circuit 13, the thermo sensor 14, and the replica circuit 18 may exist outside of the chip 11.

Now, explanation will be given to table (correlation data) creation and a management technique according to an embodiment of the present invention.

Here, a temperature “T OTD i” and a temperature “T hot spot i” are assumed to have a relationship of T hot spot i=Ai×T OTD i+Bi (Ai and Bi denote factors) with respect to each of “n” combinations of the performances of a plurality of processing units, for example.

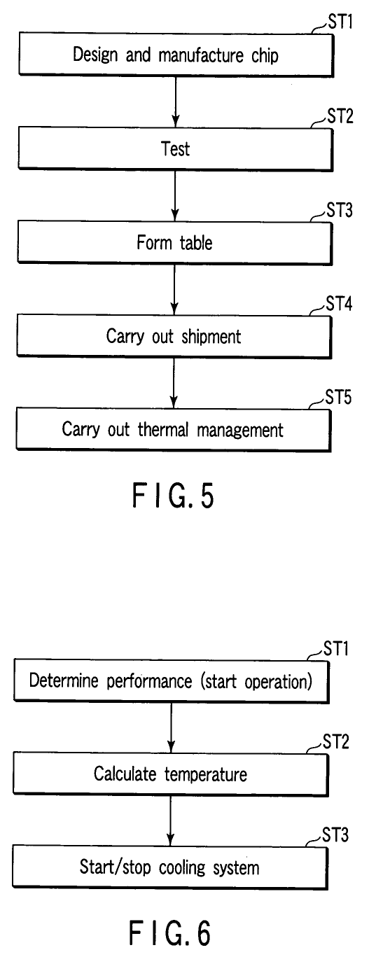

FIG. 5 shows a flow from chip formation to thermal management.

First, a chip is designed and manufactured on a manufacturer side (step ST1).

This chip is tested and a table is created (steps ST2 to ST3).

This table is assumed to show a relationship between a temperature “T OTD i” detected by a thermo sensor and an actual hot spot temperature “T hot spot i” with respect to each of “n” combinations of the performances of the plurality of processing units, as shown in, for example, FIG. 2 or FIG. 4.

Thereafter, chip shipment is carried out (step ST4).

FIG. 6 shows thermal management (step ST5) shown in FIG. 5.

When the performances of the plurality of processing units are determined, operation is started by the plurality of processing units (step ST1).

Chip temperature detection (monitoring) is always carried out whether or not operation starts/terminates. When the performances of the plurality of processing units are determined, temperature calculation is made based on performance data and a temperature “T OTD i” detected by a thermo sensor, and a hot spot temperature “T hot spot i” is estimated (step ST2).

When the hot spot temperature “T hot spot” is equal to or greater than a predetermined value, the cooling system is started, and a chip is cooled. On the other hand, when the hot spot temperature “T hot spot” is lower than the predetermined value, the cooling system is stopped (step ST3).

According to the management technique as described above, temperatures of hot spots can be precisely estimated based on a table provided in advance even by thermo sensors whose number is smaller than that of the hot spots, as long as performances of a plurality of processing units and temperatures detected by thermo sensors are identified.

Accordingly, total thermal management of precisely grasping the temperatures of all the hot spots can be achieved.

### SECOND EMBODIMENT

In a second embodiment, explanation will be given to a thermal management system of a semiconductor integrated circuit that achieves a management technique of estimating temperatures of hot spots based on redundancy data obtained by a logic redundancy function and temperatures detected by thermo sensors.

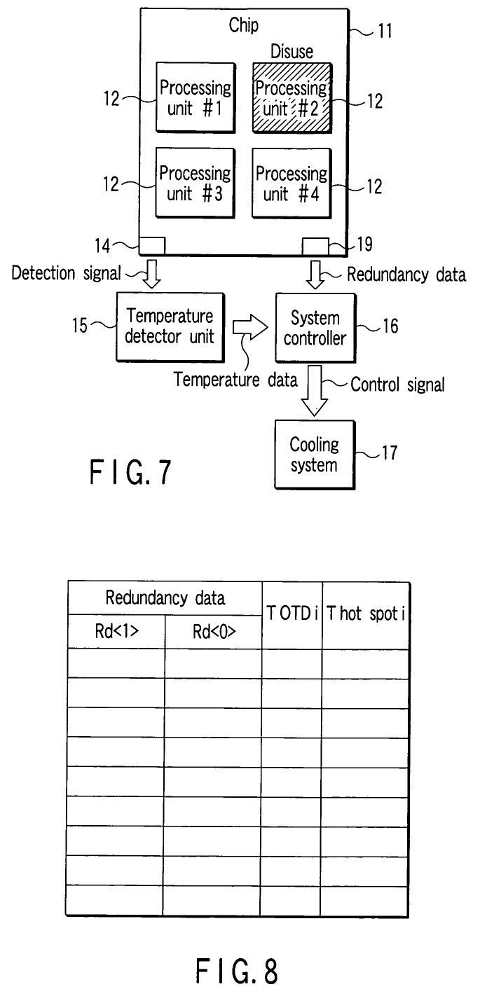

FIG. 7 shows a thermal management system according to the second embodiment.

A plurality of processing units (#1, #2, #3 and #4) 12 are allocated in a chip (semiconductor integrated circuit) 11. Each of the processing units 12 serves as a hot spot at the time of operation.

A thermo sensor 14 and a redundancy control circuit 19 are allocated in the chip 11.

The thermo sensor 14 is composed of, for example, an OTD, and outputs to the outside of the chip 11 a detection signal depending on a chip temperature.

A temperature detector unit 15 obtains a chip temperature based on the detection signal provided from the servo sensor 14, and outputs the obtained chip temperature as temperature data.

Although in this embodiment, the thermo sensor 14 is allocated in the chip 11, and the temperature detector unit 15 is allocated outside of the chip 11, both of them can be allocated in the chip 11 instead of these allocations.

The redundancy control circuit 19 has, for example, a fuse circuit. Redundancy data is stored in the fuse circuit and the redundancy data is outputted to the outside of the chip 11.

The redundancy data used here, as described previously, denotes data indicating use/disuse of the plurality of processing units 12, and the redundancy data is written into the fuse circuit after testing the chip 11 before shipment.

In the case where the redundancy control circuit 19 is composed of a fuse circuit, the fuse circuit may be a laser fuse that carries out a laser write operation or may be an electrical fuse (E-fuse) that electrically carries out a write operation.

A system controller 16 estimates temperatures of hot spots based on redundancy data provided from the redundancy control circuit 19 and temperature data provided from the temperature detector unit 15, and outputs a control signal that controls start/stop of a cooling system (for example, cooling fan) 17.

Temperatures of hot spots are, for example, as shown in FIG. 8, estimated based on a table (correlation data) summarizing a relationship between a temperature “T OTD i” detected by a thermo sensor 14 and an actual hot spot temperature “T hot spot i”.

This table is obtained in advance by testing the chip 11 before shipment.

The temperatures of hot spots are estimated based on redundancy data, whereby a difference between an estimated temperature and an actual temperature can be eliminated to improve precision.

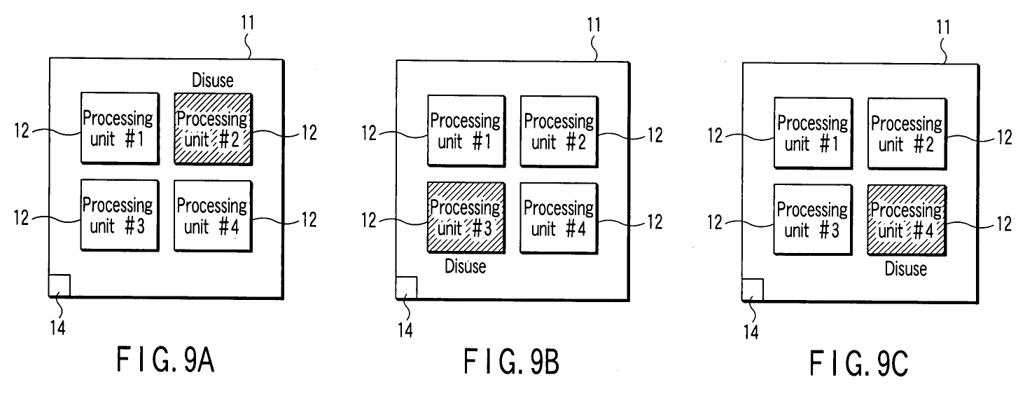

For example, as shown in FIG. 9, assuming that a position of the thermo sensor 14 does not change, a temperature distribution in the chip 11, i.e., a value of the detection signal detected by the thermo sensor 14 changes depending on whether or not an unavailable processing unit 12 exists, and further, depending on at which position such an available processing unit 12 exits if any.

By utilizing redundancy data, a temperature of such a hot spot can be precisely estimated even if a positional relationship between the thermo sensor 14 and a normal processing unit serving as a hot spot changes as shown in FIG. 9. As a consequence, a drive rate of the cooling fan can lowered, and cooling cost can be reduced.

The redundancy data can be represented by k-bit data because combinations of use/disuse of these processing units are 2^{k}, assuming that the number of processing units is k.

Although in this embodiment, only one thermo sensor 14 is allocated in the chip 11, a plurality of thermo sensors may be allocated in the chip 11 instead.

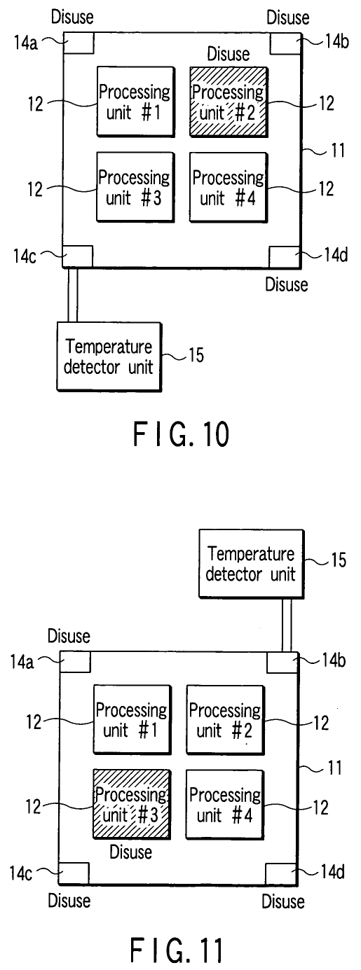

FIGS. 10 and 11 each show a thermal management system according to a modified example of the second embodiment.

The modified example is featured in that a plurality of thermo sensors 14a, 14b, 14c and 14d are allocated in a chip 11, and that use/disuse of the thermo sensors 14a, 14b, 14c and 14d is determined based on redundancy data, i.e., use/disuse of a plurality of processing units 12 (#1, #2, #3 and #4).

In this modified example, a redundancy control circuit, a system controller, and a cooling system are not shown in order to simplify an explanation. However, as in the second embodiment, these elements are, of course, required when executing a management technique relating to an embodiment of the present embodiment.

It is advantageous that a distance between a normal processing unit 12 serving as a hot spot and each of the thermo sensors 14a, 14b, 14c and 14d for use in detection of a chip temperature is as close as possible in order to estimate a precise temperature of a hot spot.

Therefore, in the case where the processing unit (#2) 12 is disused, the thermo sensor 14c is used to detect a chip temperature, for example, as shown in FIG. 10. The thermo sensors 14a, 14b and 14d are disused, but the thermo sensors 14a and 14d may be detect a chip temperature.

As shown in FIG. 11, in the case where the processing unit (#3) 12 is disused, the thermo sensor 14b is used to detect a chip temperature. The thermo sensors 14a, 14c and 14d are disused, but the thermo sensors 14a and 14d may be detect a chip temperature.

As described above, the number of thermo sensors for use in detection of a chip temperature may be plural without being limited to one sensor.

A selection of the thermo sensors 14a, 14b, 14c and 14d can be made at the time of testing before shipment or at the time of packaging.

Table creation and a management technique have been described in the first embodiment. In the second embodiment, however, a phrase “performances of a plurality of processing units” is changed to “use/disuse of a plurality of processing units” in order to utilize redundancy data.

The use/disuse of a plurality of processing units is equivalent to the presence or absence of activation of a plurality of processing unit contained in performance data. Therefore, redundancy data can be stored as performance data in a fuse circuit embedded in the chip 11.

According to the management technique as described above, the temperatures of hot spots can be precisely estimated based on a table provided in advance even by thermo sensors whose number is smaller than that of hot spots, as long as the use/disuse of a plurality of processing units (redundancy data) and temperatures detected by the thermo sensors are identified.

Consequently, total thermal management of precisely grasping the temperatures of all the hot spots can be achieved.

### THIRD EMBODIMENT

In a third embodiment, explanation will be given to a thermal management system of a semiconductor integrated circuit that achieves a management technique of detecting a chip internal average temperature (macroscopic temperature) and a chip internal minimum temperature (local temperature), and estimating a chip internal maximum temperature (hot spot temperature) based on both of the average and minimum temperatures.

The third embodiment is effective in integrated circuits (such as microcomputers) in recent years which suffer from a problem that a circuit density in an area which a hot spot is provided is high, a thermo sensor cannot be allocated there, and further, the number of thermo sensors cannot be sufficiently secured with respect to the number of processing units.

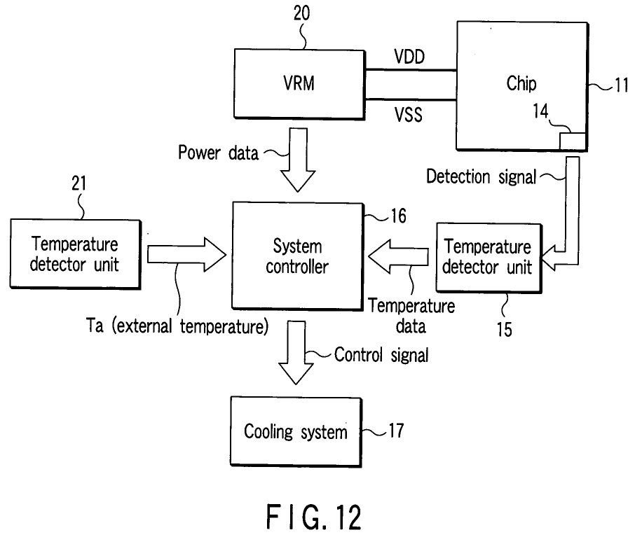

FIG. 12 shows a thermal management system according to the third embodiment.

The type of a chip 11 is not limited in particular as long as it has a thermo sensor 14. The thermo sensor 14 is allocated at, for example, a corner of the chip 11 in order to detect a minimum temperature in the chip 11.

The thermo sensor 14 is composed of, for example, an OTD, and outputs to the outside of the chip 11 a detection signal depending on a chip temperature.

A temperature detector unit 15 obtains a chip temperature based on the detection signal from the thermo sensor 14, and outputs the obtained chip temperature as temperature data. The temperature detector unit 15 can be allocated in the chip 11 as well.

Here, the thermo sensor 14 can detect only a chip internal minimum temperature (local temperature). Further, it is difficult to increase the number of thermo sensors 14 in the chip 11 from the viewpoint of a chip area or an overhead in the number of pads (terminals).

Therefore, in the third embodiment, a voltage regulator module (VRM) 20 having a droop control function is used. In such a VRM 20 having a droop control function, it is possible to monitor power consumption of a chip from an output voltage because the output voltage is set in response to current consumption. Chip power consumption data thus obtained from the VRM 20 is inputted to a system controller 16.

In addition, a temperature detector unit 21 detects a temperature Ta of the outside of the chip 11 (external temperature), and supplies the data to the system controller 16.

The system controller 16 estimates a chip internal maximum temperature (hot spot temperature) based on power data from the VRM 20 and temperature data from the temperature detector units 15 and 21.

First, an average temperature Tj of the inside of the chip 11 is represented by Tj=Ta +θja×P.

Ta denotes a temperature of the outside of the chip 11, θja denotes a heat resistance of the chip 11, and P denotes a heat rate of the chip 11 (=power consumption).

Therefore, as long as the temperature Ta of the outside of the chip 11 and the heat resistance θja of the chip 11 are given, the power consumption P of the chip 11 is monitored as power data, whereby the average temperature Tj of the chip 11 can be calculated.

Next, assuming that temperature distributions of the inside of the chip 11 are represented by, for example, a linear equation, a chip internal maximum temperature Tmax is obtained by Tmax=Tj+A×(Tj−Tmin).

Tmin denotes a minimum temperature in the chip 11 detected by the thermo sensor 14, and A denotes a parameter determined by testing (including analysis at the time of designing).

The system controller 16 estimates the chip internal maximum temperature (hot spot temperature) Tmax in accordance with the procedures described above.

According to such a technique, local (wholly invisible) property of the thermo sensor 14 and macroscopic (partially invisible) property of the VRM 20 are complemented for each other, so that the temperatures of hot spots can be precisely estimated even by thermo sensors whose number is smaller than that of the hot spots.

Consequently, total thermal management of precisely grasping the temperatures of all the hot spots can be achieved.

Further, the thermo sensor 14, there is no need for allocating the sensor in the vicinity of a hot spot. For example, the thermo sensor 14 may be allocated at a corner of the chip 11, and therefore, the degree of freedom in layout of a semiconductor integrated circuit increases.

According to the embodiments of the present invention, it is possible to provide a management technique of precisely grasping temperatures of all hot spots by means of thermo sensors whose number is smaller that that of hot spots.

The embodiments of the present invention can be applied to a high speed processing apparatus or the like having a plurality of processing units which are operable independently in addition to general processors such as a graphics processing unit (GPU) and a central processing unit (CPU).

In all the embodiments, a temperature detector unit and a system controller may be loaded together in a chip.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A thermal management system comprising:
processing units which are provided in a chip;
a performance monitor circuit which monitors performances of the processing units and outputs performance data;
a thermo sensor which provided in the chip, the thermo sensor outputting a detection signal relating to a chip temperature;
a temperature detector unit which outputs temperature data based on the detection signal; and
a system controller which stores a table representing a relationship among the performances of the processing units, the chip temperature and a temperature of a hot spot, and estimates a temperature of the hot spot based on the performance data and the temperature data by using the table.

2. The thermal management system according to claim 1, further comprising a cooling system which starts when the temperature of the hot spot is equal to or higher than a predetermined value, and stops when the temperature is lower than the predetermined value.

3. The thermal management system according to claim 1, wherein the table is created based on a result of a test of the chip.

4. The thermal management system according to claim 1, wherein the performances include one of a presence, absence or frequency of activation, and a type or quantity of a task.

5. A thermal management system comprising:
processing units which are provided in a chip;
a performance monitor circuit which monitors performances of the processing units and outputs performance data;
a replica circuit which replicates heat rates of the processing units based on the performance data;
a thermo sensor adjacent to the replica circuit, the thermo sensor outputting a detection signal relating to a temperature of the replica circuit;
a temperature detector unit which outputs temperature data based on the detection signal; and
a system controller which stores a table representing a relationship between the temperature of the replica circuit and a temperature of a hot spot, and estimates the temperature of the hot spot based on the temperature data by using the table.

6. The thermal management system according to claim 5, wherein the performance monitor circuit, the replica circuit, and the thermo sensor are allocated in the chip.

7. The thermal management system according to claim 5, further comprising a cooling system which starts when the temperature of the hot spot is equal to or higher than a predetermined value, and stops when the temperature is lower than the predetermined value.

8. The thermal management system according to claim 5, wherein the table is created based on a result of a test of the chip.

9. The thermal management system according to claim 5, wherein the performances include one of a presence, absence or frequency of activation, and a type or quantity of a task.

10. A thermal management system comprising:
processing units which are provided in a chip;
a redundancy control circuit provided in the chip, the redundancy control circuit outputting redundancy data which indicates use/disuse of the processing units;
a thermo sensor provided in the chip, the thermo sensor outputting a detection signal relating to a chip temperature;
a temperature detector unit which outputs temperature data based on the detection signal; and
a system controller which stores a table representing use/disuse of the processing units and a relationship between the chip temperature and a temperature of a hot spot, and estimates the temperature of the hot spot based on the redundancy data and the temperature data by using the table.

11. The thermal management system according to claim 10, further comprising a cooling system which starts when the temperature of the hot spot is equal to or higher than a predetermined value, and stops when the temperature is lower than the predetermined value.

12. The thermal management system according to claim 10, wherein the table is created based on a result of a test of the chip.

13. A thermal management system comprising:
processing units which are provided in a chip;
thermo sensors which are provided in the chip; and
a temperature detector unit which outputs temperature data relating to a chip temperature based on a detection signal of at least one of the thermo sensors,
wherein use/disuse of the thermo sensors is determined based on use/disuse of the processing units.

14. The thermal management system according to claim 13, wherein the at least one thermo sensor is closed to a processing unit which is used.

15. The thermal management system according to claim 13, wherein the thermo sensors are provided to be associated with the processing units.

16. The thermal management system according to claim 13, wherein the thermo sensors are provided at all of corners of the chip.

17. A thermal management system comprising:
a thermo sensor provided in a chip, the thermo sensor outputting a detection signal relating to a chip temperature;
a first temperature detector unit which outputs first temperature data based on the detection signal;
a second temperature detector unit which outputs second temperature data relating to a temperature of the outside of the chip;
a power supply circuit which monitors power consumption of the chip and outputs power data; and
a system controller which estimates a temperature of a hot spot from the first and second temperature data and the power data.

18. The thermal management system according to claim 17, further comprising a cooling system which starts when the temperature of the hot spot is equal to or higher than a predetermined value and stops when the temperature is lower than the predetermined value.

19. The thermal management system according to claim 17, wherein the first temperature data represents a minimum temperature of the inside of the chip, and the system controller obtains an average temperature of the inside of the chip from the second temperature data and the power data, and estimates the temperature of the hot spot based on the minimum temperature and the average temperature.

20. The thermal management system according to claim 17, wherein the thermo sensor is provided at a corner of the chip.
